(19) United States
(12) Patent Application Publication
(10) Pub. No.: US 2008/0147814 A1
(43) Pub. Date: Jun. 19, 2008

(54) Systems and methods for unique electronic mail message links

(75) Inventors: Roberto Francisco Bargagli Damm, Queretaro (MX); Luis Felipe Paredes Flores, Queretaro (MX); Eric Arturo Nunez Farfan, Queretaro (MX)

Correspondence Address: MEYERTONS, HOOD, KIVLIN, KOWERT & GOETZEL, P.C., P.O. BOX 398, AUSTIN, TX, 78767-0398, US

(73) Assignee: Tralix, L.L.C.

(21) Appl. No.: 11/981,571

(22) Filed: Oct. 31, 2007

Related U.S. Application Data
(63) Continuation of application No. 10/377,302, filed on Feb. 28, 2003.
(60) Provisional application No. 60/360,860, filed on Mar. 1, 2002.

(51) Int. Cl. G06F 15/16

(52) U.S. Cl. 709/206

(57) ABSTRACT

An embedded mail object to include in electronic mail messages. In one embodiment, a method may include associating an embedded mail object with a unique electronic mail message. For example, an embedded mail object may include a newsletter, a survey, a quiz, or a promotion. The electronic mail messages may be transmitted to a recipient. Data about the recipient may be received and processed to present results or send another round of electronic mail messages. Embedded mail objects may also be used to keep track of which electronic mail message subjects are responded to more often to improve electronic mail message advertising. Embedded mail messages may also allow secure transactions between a recipient and the user of the electronic mail message.

### PRIORITY CLAIM

This application is a continuation application of U.S. patent application Ser. No. 10/377,302 titled “Method and System of Sending and Tracking Electronic Mail Messages” which was filed Feb. 28, 2003 whose inventors are Roberto Francisco Bargagli Damm, Luis Felipe Paredes Flores, and Eric Arturo Nunez Farfan which is hereby incorporated by reference in its entirety as though fully and completely set forth herein. U.S. patent application Ser. No. 10/377,302 claimed the benefit of priority of provisional application Ser. No. 60/360,860 titled “Method and System of Sending and Tracking Electronic Mail Messages” filed on Mar. 1, 2002, whose inventors are Roberto Bargagli Damm and Luis Felipe Paredes Flores.

### BACKGROUND OF THE INVENTION

1. Field of the Invention

The present invention relates generally to the field of communication networks and electronic mail (electronic mail message) list management systems. More specifically, the present invention relates to a method and system of sending, tracking and embedding certain interactive functionality within electronic mail messages.

2. Description of the Related Art

Conventional electronic mail message list management systems are particularly limited in the ease and efficiency with which electronic mail messages may be created and with which electronic mail message lists may be managed, the content which may be included within an electronic mail message transmitted to a list, and the ease of extracting useful information about the use and/or transaction capability from the recipient, as well as to determine the effectiveness of a given electronic mail message list.

### SUMMARY OF THE INVENTION

In one embodiment, a user may define Embedded Mail Objects (EMOs) to include in electronic messages. In one embodiment, a method may include associating an embedded mail object with a unique electronic mail message, transmitting the unique electronic mail message to a recipient, receiving data from the recipient utilizing the embedded mail object on a user level, and retrieving the received data directly from the unique electronic mail message.

In one embodiment, a method may include generating a uniform resource locator for a web document, the uniform resource locator including a classification identifier associated with a class, transmitting the uniform resource locator to a user, receiving a request for the web document including the uniform resource locator from the user, and identifying the class utilizing the classification identifier.

In one embodiment, a method may include transmitting an electronic mail message including a first subject line to each of a first plurality of recipients, transmitting the electronic mail message including a second subject line to each of a second plurality of recipients, monitoring an attribute of the transmitted electronic mail messages, and automatically associating one of the first subject line and the second subject line with the electronic mail message, and transmitting the electronic mail message to each of a third plurality of recipients in response to monitoring an attribute of the transmitted electronic mail messages.

In one embodiment, a method may include generating a plurality of electronic mail messages, automatically attaching a unique secure document to each of the plurality of electronic mail messages, and transmitting each of the plurality of electronic mail messages to a corresponding one of a plurality of recipients. In one embodiment, a method may include selecting a data element from a plurality of data elements within a database, generating a database view based on the selected data element, generating a plurality of electronic mail messages, fetching data from the database view, and incorporating the fetched data from the database view into the plurality of electronic mail messages. In one embodiment, a method may include transmitting an image data file from a remote client data processing system to a local server data processing system, storing the image data file within the local server data processing system, incorporating the image data file within a plurality of electronic mail messages, transmitting the plurality of electronic mail message utilizing the local server data processing system.

In one embodiment, a method may include constructing a natural language query by example statement including a plurality of fields, identifying a plurality of recipients utilizing the natural language query by example statement, converting the natural language query by example statement to a structured query language statement, transmitting a data message and the structured query language statement to a server data processing system, executing the structured query language statement at the server data processing system, and generating an electronic mail message for each of a plurality of recipients at the server data processing system in response to executing the structured query language statement. In one embodiment, natural language may also be used to export data. For example, while a user is building a message, data may be exported from the user's database.

### BRIEF DESCRIPTION OF THE DRAWINGS

A better understanding of the present invention may be obtained when the following detailed description is considered in conjunction with the following drawings, in which:

FIG. 1 illustrates a high-level functional block diagram, according to one embodiment;

FIG. 2 illustrates a display output of an Admin Client component, according to one embodiment;

FIG. 3 illustrates a first display output of an Editor Client component, according to one embodiment;

FIG. 3a illustrates an electronic mail message using an EMO developed by the Editor Client;

FIG. 4 illustrates a second display output of an Editor Client component, according to one embodiment;

FIG. 5 illustrates a third display output of an Editor Client component, according to one embodiment;

FIG. 6 illustrates a first logical block diagram of a system including one or more EMOs, according to one embodiment;

FIG. 7 illustrates a second logical block diagram of a system including one or more EMOs, according to one embodiment;

FIG. 8 illustrates a first display output of an EMO Wizard component, according to one embodiment;

FIG. 9 illustrates a second display output of an EMO Wizard component, according to one embodiment;

FIG. 10 illustrates a third display output of an EMO Wizard component, according to one embodiment;

FIG. 11 illustrates a fourth display output of an EMO Wizard component, according to one embodiment;

FIG. 12 illustrates a functional block diagram of the retrieval of data using a query by example tool, according to one embodiment;

FIG. 13 illustrates a first display output of an Import Client component, according to one embodiment;

FIG. 14 illustrates a second display output of an Import Client component, according to one embodiment;

FIG. 15 illustrates a first display output of an Admin Client component, according to one embodiment;

FIG. 16 illustrates a first display output of a Report Module component, according to one embodiment;

FIG. 17 illustrates a second display output of a Report Module component, according to one embodiment;

FIG. 18 illustrates a communication network, according to one embodiment; and

FIG. 19 illustrates a functional block diagram of an App Service Module component, according to one embodiment;

FIG. 20 shows a flowchart of an embodiment of embedding EMOs, according to one embodiment;

FIG. 21 shows a flowchart of an embodiment of using URLs with EMOs, according to one embodiment;

FIG. 22 shows a flowchart of an embodiment of monitoring subject lines for electronic mail messages with EMOs, according to one embodiment;

FIG. 23 shows a flowchart of an embodiment of attaching secure documents to electronic mail messages with EMOs, according to one embodiment;

FIG. 24 shows a flowchart of an embodiment of incorporating database information in an electronic mail message with a EMO, according to one embodiment;

FIG. 25 shows a flowchart of an embodiment using a remote client system and a local server, according to one embodiment; and

FIG. 26 shows a flowchart of an embodiment of using structured query language with EMOs, according to one embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF SEVERAL EMBODIMENTS

The following detailed description pertains to a method and system of sending, tracking, and embedding certain interactive functionality within electronic mail messages. Embodiments of the described method and system may include various features, and may be implemented in a variety of ways. For example, such embodiments may include various communications networks and data processing systems arranged in any of a number of configurations and including various hardware, firmware, and/or software components.

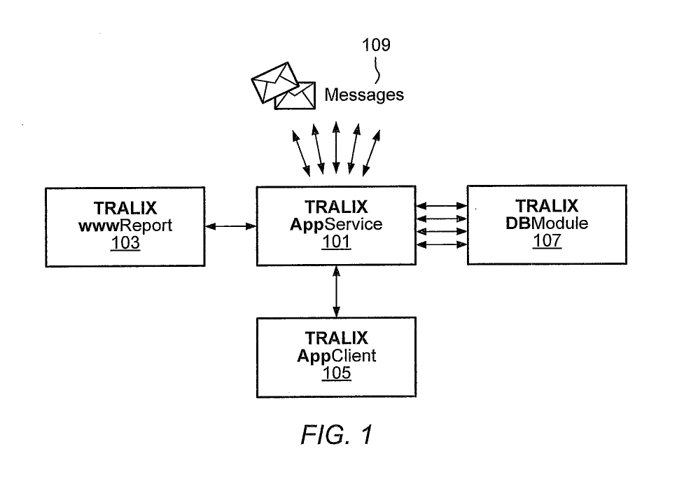

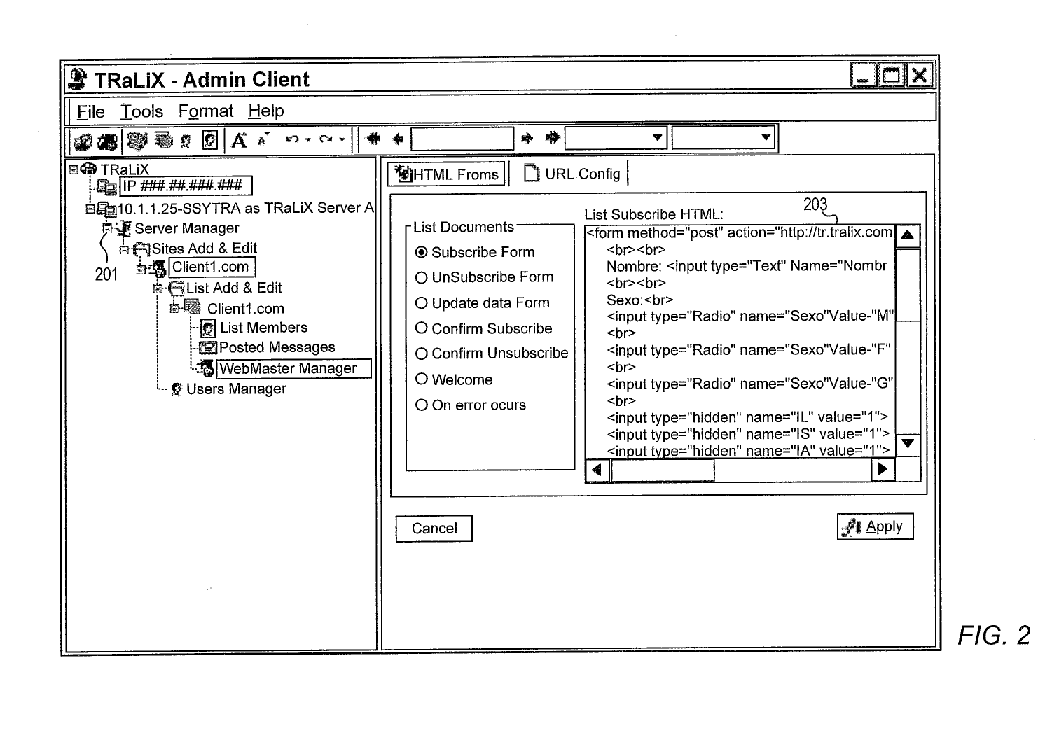

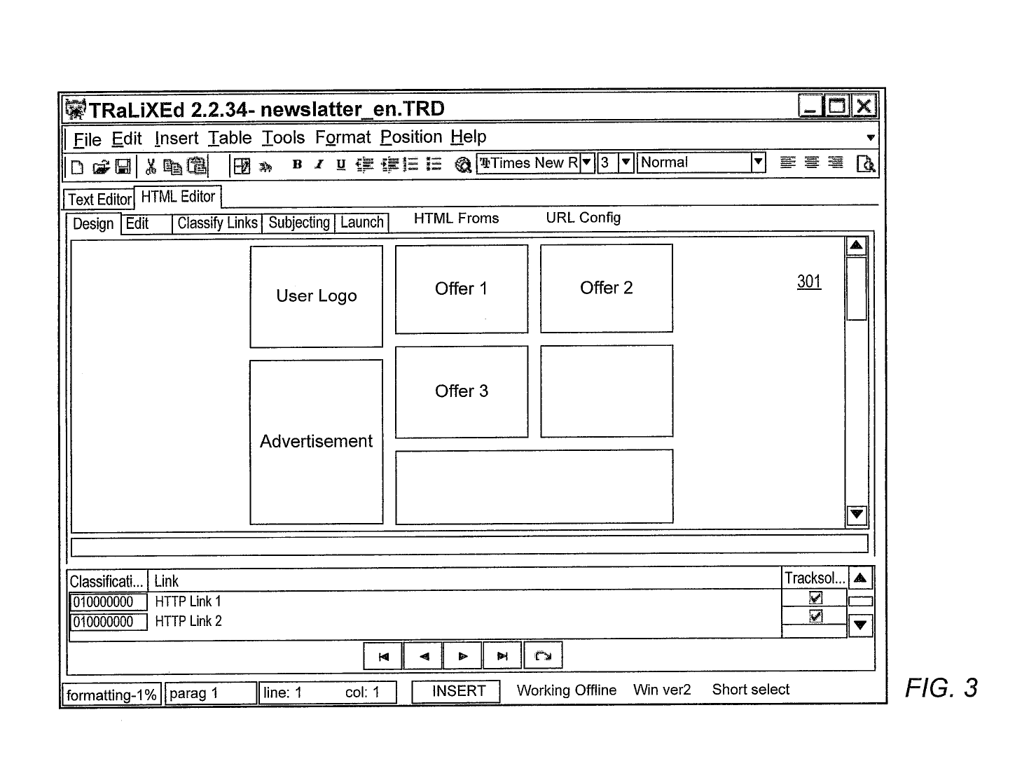

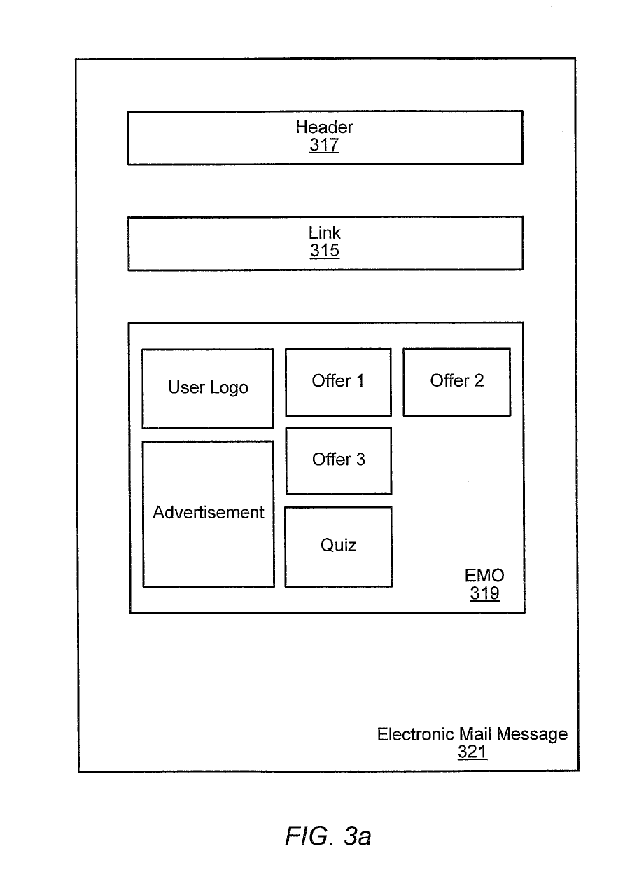

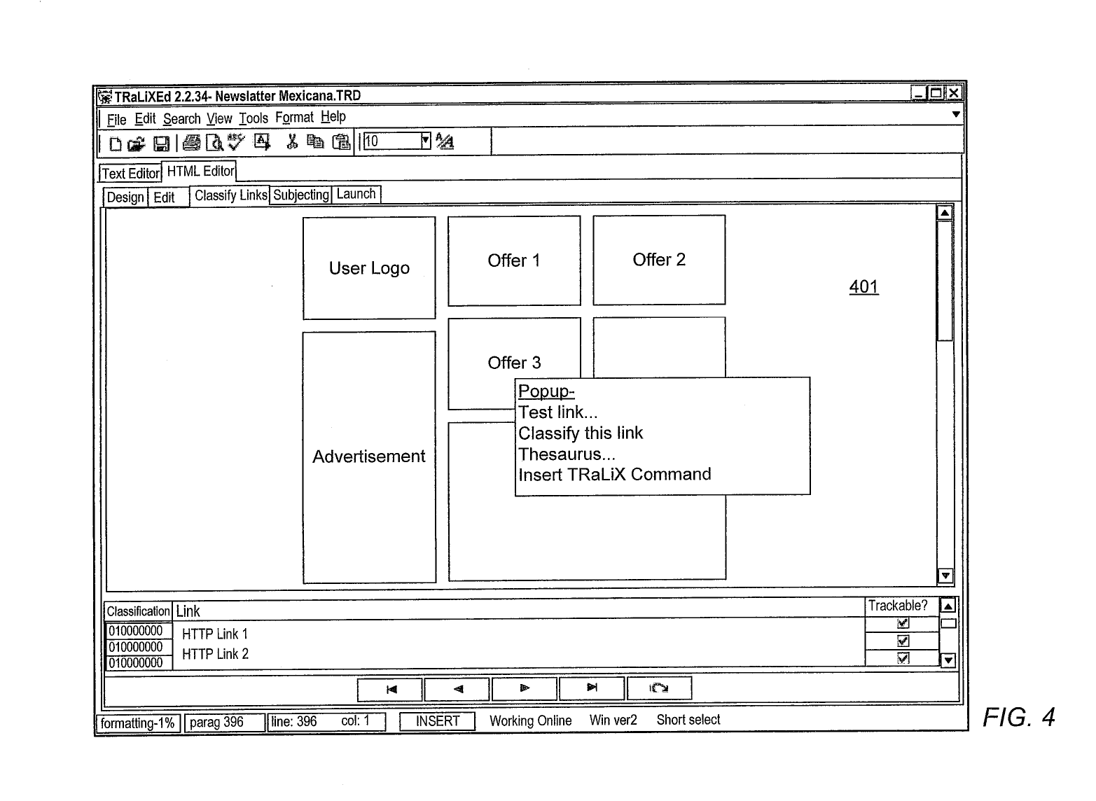

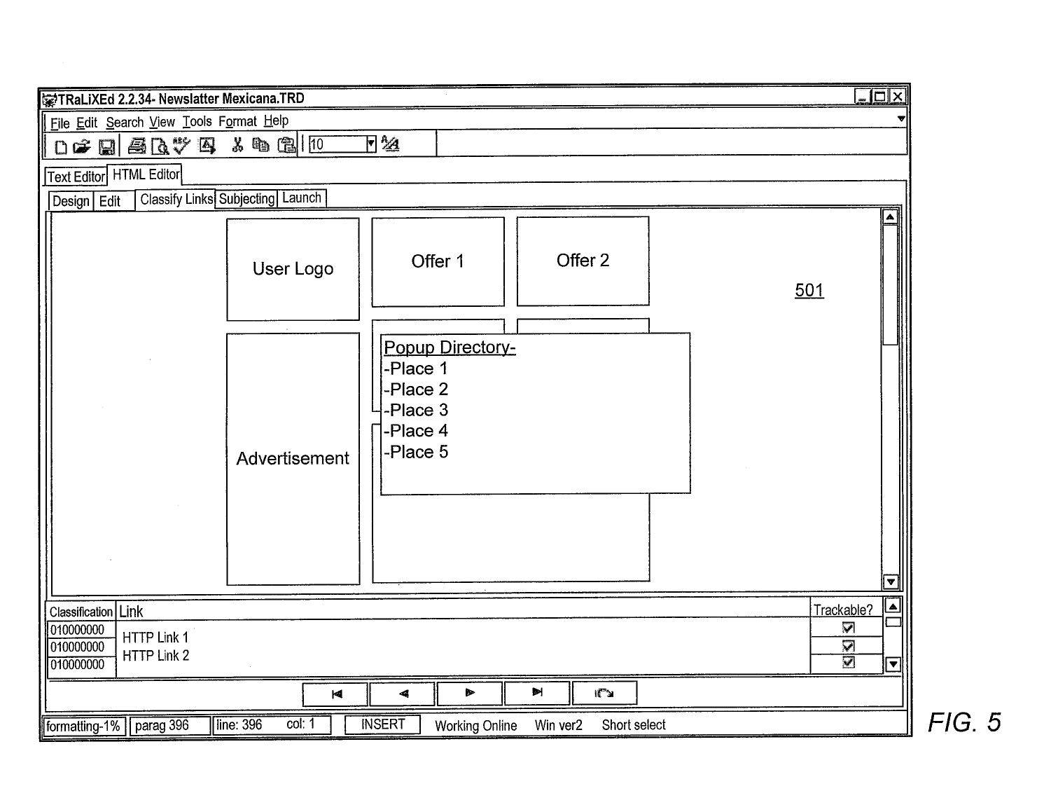

FIG. 1 shows an embodiment of a high-level functional block diagram of a system for performing an embodiment. In the description below, particular embodiments are described. In one referenced embodiment, a system for sending and tracking electronic mail (electronic mail message) messages 109 is disclosed including components organized in an application service provider (ASP) model. Attributes of the described embodiments such as the number of components, component organization, and component references (e.g., App Service Module 101, Report Engine 103, App Client Module 105, Admin Client (see FIG. 2), Import Client (not shown), Editor Client (see FIGS. 3, 4, and 5), DB Module 107, etc.) are presented for illustrative purposes only and should not be considered as limiting other alternative embodiments.

FIG. 2 illustrates an embodiment of a display output of an Admin Client component. In one embodiment, the Admin Client may have a high-level hierarchy tree 201. By utilizing the admin client, the end user may be capable of administering certain performance characteristics of an electronic mail message campaign and access the information used for the electronic mail message campaign by assigning attributes to list members, messages, and users for the campaign. As used herein a campaign may include, but is not limited to, an advertising campaign performed through electronic mail messages. The hierarchy may begin at the server level, the site level, the list level, the client level, the message level, and/or the user level. The hierarchy may include other levels and other level orders.

FIGS. 3, 4, and 5 show several screen shots of the Editor Client which may utilize a “drag and drop” user friendly interface. The Editor Client may be capable of designing a rich electronic mail message, inserting several embedded mail objects (such as text and images). In one embodiment of the Editor Client, functionality may be added to allow the user to insert and classify links to objects in an electronic mail message and prepare the reporting engine to track information about recipients of the electronic mail messages and responses from the recipients of the electronic mail messages. In addition, FIG. 3a illustrates an electronic mail message using an EMO developed by the Editor Client. For example, the electronic mail message 321 may have the EMO 319. In one embodiment, the electronic mail message 321 may have a link 315 and a header 317.

Within the figures, appendices, and this description of the various embodiments the prefix “TR” is utilized to indicate a component, however it should be appreciated that embodiments may be implemented with a wide variety of components without departing from the broader spirit and scope of the present invention. Similarly, the names associated with the various described or depicted components may be truncated for simplicity (e.g., App rather than Application, TREditor rather than Editor Client, etc.).

### Embedded Mail Objects

One embodiment may include embedding one or more Embedded Mail Objects (EMOs) in an electronic mail message. In one embodiment, the EMO may include at least two parts, a user part and a server part. The User Part may include objects (such as, but not limited to text, forms, and images) that a user can easily add to an outbound electronic mail message using an EMO Wizard component. In one embodiment, the server part may include support data and programming for the EMO.

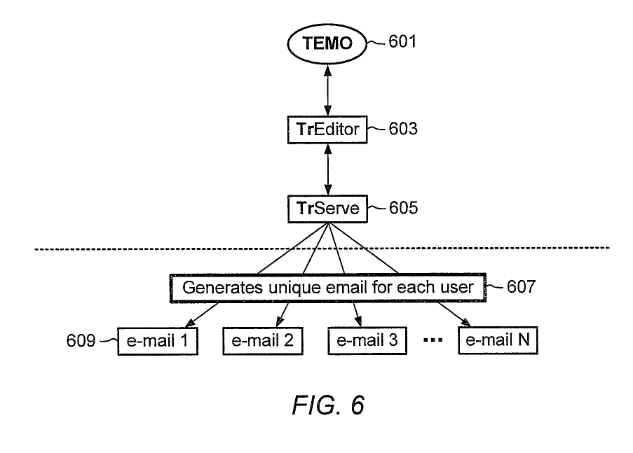

FIG. 6 illustrates a first logical block diagram of a system including one or more EMOs 601 according to one embodiment. In one embodiment, EMOs may include text and images comprising objects such as, but not limited to, a newsletter, survey, quiz, vote, or promotion. Other objects are also contemplated. In one embodiment, the Editor Client 603 may have preset EMOs 601. In another embodiment, the user may create new EMOs 601. The Editor Client 603 may transfer the EMOs to the App Service 605 to be inserted into the electronic mail messages after editing the EMOs. In one embodiment, EMOs 601 may still be editable after being inserted into the electronic mail message. In another embodiment, EMOs 601 may be generated on a user level. In one embodiment, a unique electronic mail message may be created for each recipient 607 using an EMO 601. As used herein, “unique” may refer to a personalized electronic mail message. The electronic mail messages 609 may then be distributed to recipients.

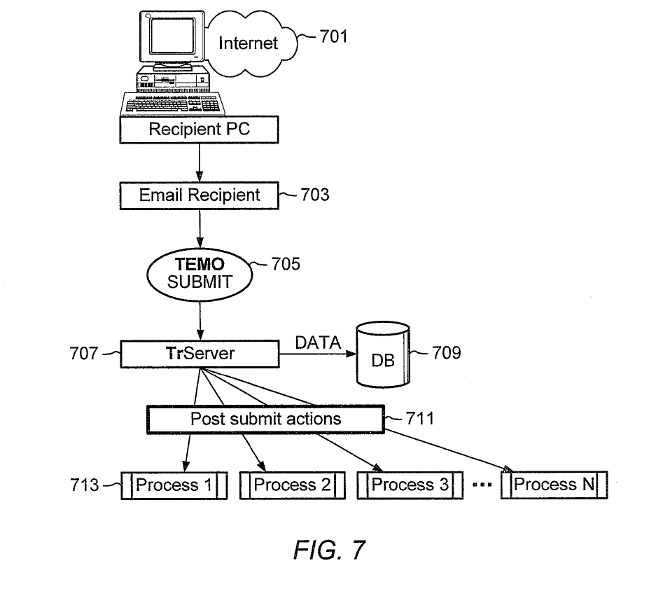

FIG. 7 illustrates a second logical block diagram of a system including one or more EMOs, according to one embodiment. In one embodiment, the recipient 703 may transact with an EMO on the recipient's personal computer (PC) 701 and submit EMO data 705 to the App Server 707. In one embodiment, the App Server 707 may add data in a database 709 and take validation actions such as, but not limited to, check an expiration date, check a first number of users, and check a first number of answers. In one embodiment, the App Server 707 may take post submit actions 711 such as redirect the recipient to a certain Uniform Resource Locator (URL) 713, update a list of extended fields, generate a unique response electronic mail message, generate a Telephone Application Protocol (TAP) message, and generate a Wireless Application Protocol (WAP) message. Other App Server 707 functions are also contemplated.

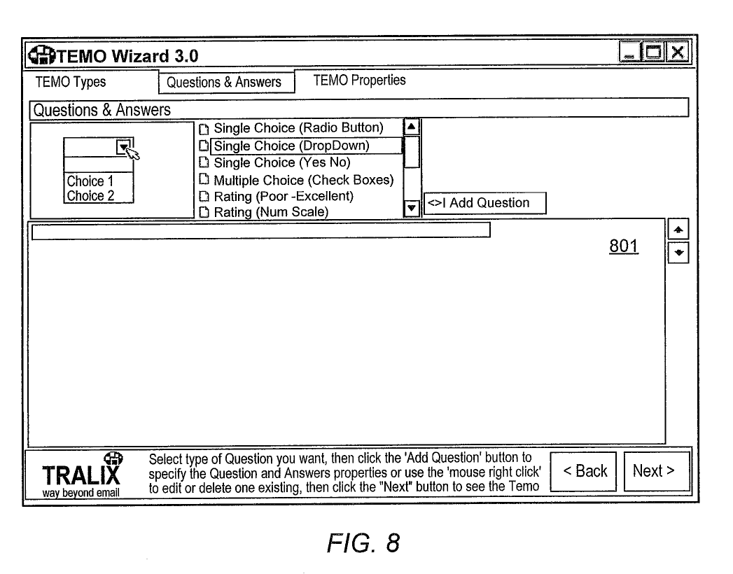

FIG. 8 illustrates a first display output of an EMO Wizard component, according to one embodiment. Utilizing the EMO Wizard 801 component, a user may not be required to have any Hypertext Markup Language (HTML) or programming knowledge to create or validate an object or form. An EMO may contain any of a number of questions with any number of answers. In one embodiment, a question in the EMO may have various properties such as answer alignment and/or associated actions, events, or instructions and can be marked as required to answer the question. According to one embodiment, an event may be a subsequent act or activity in which no end-user/recipient participation is required and an action may be a subsequent act or activity necessitating or requiring some response or participation. In one embodiment, answers may have a relation to one or more of a number of predefined Extended Database List Fields or be marked as a correct answer.

In one embodiment, a user may also set one or more of a number of general EMO properties such as titles, instructions, font, and/or width and configure an On Submit event, causing the setting of an allow multi-submit flag after submit URL redirect, on error URL redirect, and/or after submission text or a predefined action or event occurrence. In an alternative embodiment, special EMO properties may be configured as an expiration date, a number of first ‘N’ users, and/or a number of correct answers and trigger a subsequent event or action.

The server part of an EMO in the described embodiment may be an intelligent component. In one embodiment, the server part may be responsible for collecting and validating data submitted by a user to an active EMO such that all EMO submits may be reported at a user detail level or granularity. In one embodiment, the server part may also enable reports about received EMO responses from recipients. Other information about the recipient may also be included.

In one embodiment, a user may select an EMO type from a number of predefined types including, but not limited to, EMO types such as newsletter rating, newsletter forward, rated newsflashes, customer survey, customer quiz, customer rally quiz, customer exams, customer vote, customer point of view, promotions (with or without expiring offers), alerts, and bill fulfillment. Other EMOs are also contemplated.

A newsletter rating EMO may contain rating questions (e.g., a yes/no rating, a poor-excellent rating, or a numeric rating with single choice answers). A newsletter forward EMO may include or be utilized to include a text box in an outgoing mail where a user or recipient may include one or more electronic mail message addresses for forwarding. The server part of the EMO may then build a unique (i.e., personalized) electronic mail message for each referral address with tracking capabilities to the referrals and may invite referrals to subscribe to the list. A customer survey EMO may include or be utilized to create a standard survey with any number of questions in the form of radio buttons, check boxes, text boxes, pulldown menus, etc.

A customer quiz EMO may include or be utilized to create a simple user quiz, adding a variety of questions in the form of text areas, multiple choice check boxes, text boxes, pulldown menus, etc. A customer rally quiz EMO may include or be utilized to create a quiz with a time stamp schedule or configured to accept only the first ‘N’ responding users, or the first ‘N’ correct answers submitted. A customer vote EMO may include or be utilized to make a standard push poll including a number of questions. A point of view EMO may include or be utilized to create a standard EMO including text areas to determine a user's point of view. A promotion EMO may include or be utilized to create promotions with or without expiring offers (e.g., based on a time stamp schedule or configured to accept only the first ‘N’ users).

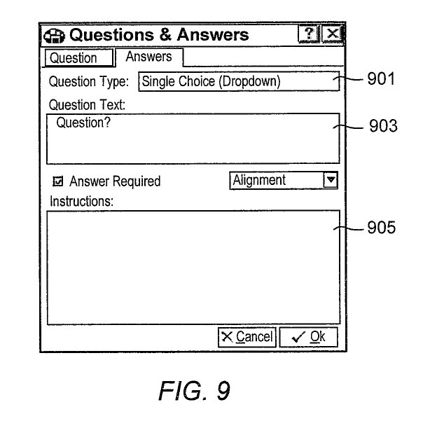

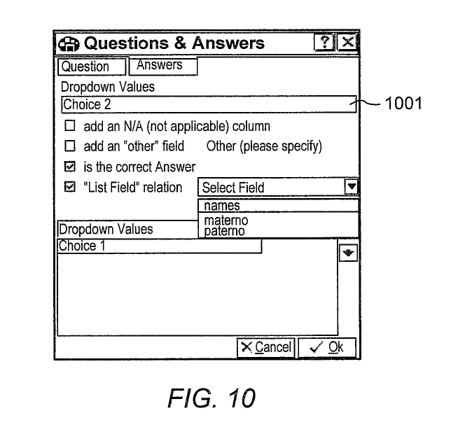

FIG. 9 illustrates a second display output of an EMO Wizard component, according to one embodiment. Once an EMO type has been selected in the described embodiment, a user then may add questions and answers to the EMO. To add a question and corresponding answer, a user may select a question type 901, compose the question text 903, choose an alignment style, add instructions 905, actions or events and may mark the question as required. FIG. 10 illustrates a third display output of an EMO Wizard component according to one embodiment. For example, a user may add corresponding answer text 1001 that may be linked with one more list extended database fields and/or marked as the correct answer. In one embodiment, question types may include, but are not limited to single choice, multiple choice, rating questions, text input questions, matrix group questions, and priority questions.

A single choice question may create radio buttons and/or combo boxes or pulldown menus from which end-users (electronic mail message recipients) may select only one answer. Single choice questions may be utilized for yes/no, male/female questions, etc. Multiple choice questions, by contrast, may create check boxes from which an end-user may select one or more answers. Rating questions may create radio buttons from which an end-user may select only one answer used (e.g., a poor-excellent rating, 1-5 rating, etc.). Text input questions create a text box which may be configured or masked to accept only numbers, text, or dates. Group questions may be utilized to create a group of single choice, multiple choice, rating and/or text input questions. Priority Questions may group questions including radio buttons where the users may specify priorities.

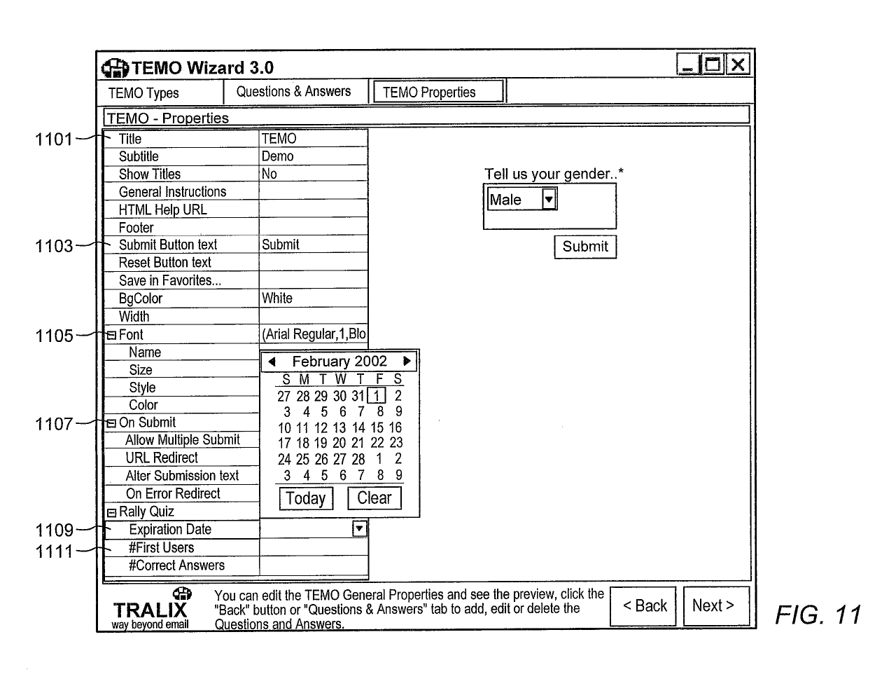

FIG. 11 illustrates a fourth display output of an EMO Wizard component, according to one embodiment. Following the addition of one or more questions and answers in the described embodiment, a user may edit various EMO properties such as titles 1101, footers, submit button text 1103, font 1105, and one or more On Submit events 1107 or actions. Additionally, a user may set EMO special properties such as an expiration date 1109, a first ‘N’ user's number 1111, and/or a first ‘N’ answers number, etc.

In one embodiment, a created EMO may be automatically inserted into an associated outgoing electronic mail message using Extensible Markup Language (XML). Thereafter, when an electronic mail message recipient/end-user submits data via an EMO associated with a received electronic mail message, a server associated with the EMO (e.g., an EMO Service Server) may validate that the user has submitted data from a valid (i.e., not expired) EMO and/or that all required questions have been answered. Once the data submission has been validated, the submitted data and related information (e.g., a user identifier, a message identifier, a list identifier, and/or a site identifier) may be stored within an associated data base on the server side. In one embodiment, the submitted data may be included in building a recipient profile for a specific recipient of an electronic mail message.

Following the submission of data via an EMO associated with a received electronic mail message detailed, recipient-specific information such as the date and/or time of the opening of the associated electronic mail message and/or the submission of the data/response, recipient answers to specific questions, etc. may be determined and reported. Similarly, a profile for a specific use may be composed and reported based on a collection of EMO data/answer submissions.

The system for embedding EMOs may include, but are not limited to, events, actions, etc. triggered directly from an electronic mail message as opposed to from a web interface (e.g., web browser client) where the activity takes place only if the end-user/electronic mail message-recipient accesses a web site, possibly requiring a user login or the use of a user identifier such a cookie, and answers the questions of a survey. In one embodiment, the system for embedding EMOs may include allowing a recipient not to have to authenticate himself or herself as compared to a web interface environment.

Because the electronic mail message transmission and tracking/reporting may be performed by the same system in the described embodiment, the identity of the specific recipient who opens the received electronic mail message and their specific answers to an EMO's associated questions may be automatically determined via one or more tracking applications. In an alternative embodiment, one or more of a number of post-submit actions may then be taken following such a determination and dependent on a recipient's answers including the creation of a complex recipient profile over time.

In one embodiment, the EMO may allow secure transactions with the recipient. For example, a credit card statement may be included with the EMO. The credit card statement may be generated with data from a client's in house database. In one embodiment, the recipient may be able to pay a credit balance by clicking a button or other indicator on the EMO. Other secure transactions are also contemplated. In addition, a secure EMO may be sent to a recipient. In one embodiment, the secure EMO may be sent to the recipient in a secure fashion using an encryption method such as, but not limited to, Secured Socket Layer (SSL) to send the EMO in a credible secure manner. For example, secure EMOs may include financial, medical, and personal information which may be sensitive. Other sensitive information may also be contemplated.

In yet another alternative embodiment, video and/or image data files, such as Moving Picture Experts Group (MPEG) format files, graphics interchange format (GIF) files, Joint Photographic Experts Group (JPEG) format files, tagged image file format (TIFF), or the like for use in EMOs may be transmitted from a remote location via a App Client Module software program and stored within a local server data processing system including a App Service Module component for transmission via one or more electronic mail messages to members or subscribers of a electronic mail message list group.

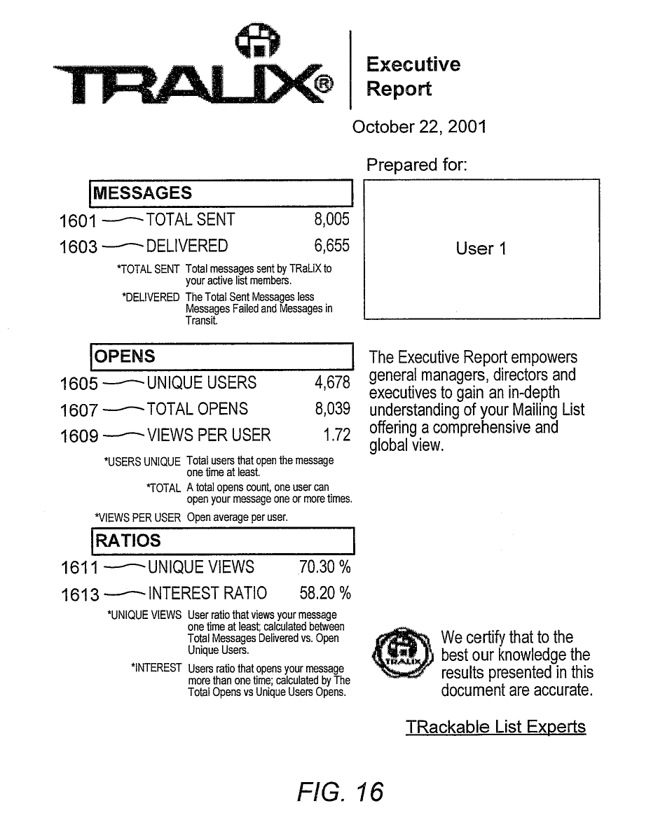

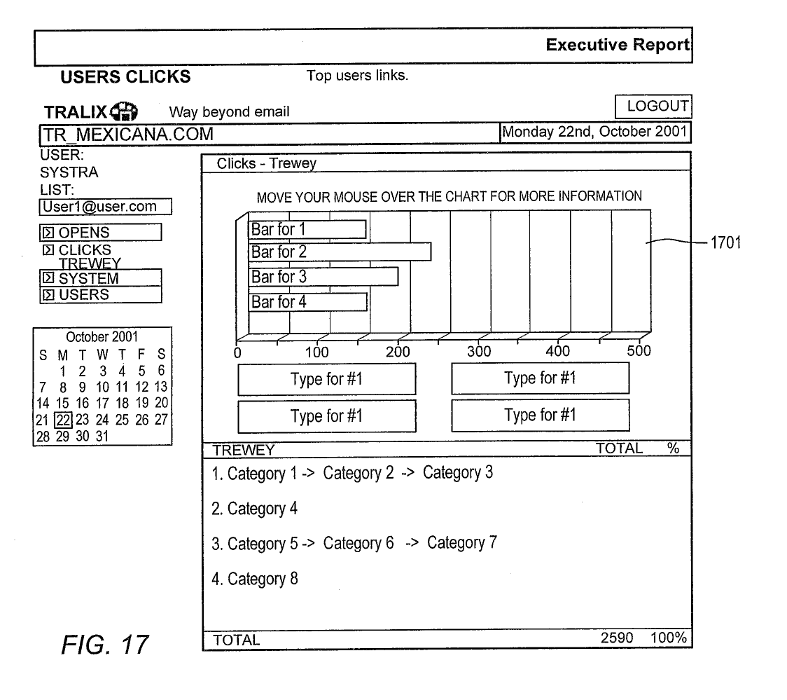

FIG. 16 illustrates an embodiment of a first display output of a Report Module component. FIG. 17 illustrates an embodiment of a second display output of a Report Module component. As the results from the EMOs are collected, reports may be generated to show the results. For example, total sent messages 1601, total delivered messages 1603, number of unique recipients 1605, total number of electronic mail messages opened 1607, total views per recipient 1609, unique views ratio 1611, and interest ratio 1613 may be reported. In addition, bar graph data 1701 for the different results may also be displayed. In one embodiment, results from the electronic mail messages may be provided as strings of information to systems such as, but not limited to Customer Relationship Management (CRM) system, a call center, a credit scoring system, a legacy system. In one embodiment, the strings of information may be extracted directly from electronic mail message with an embedded EMO.

### Query by Example

According to one embodiment, a query by example (QBE) tool may be provided (e.g., merged into the Editor Client application described herein) by which a user may define target recipients for an electronic mail message in an easy process which doesn't require a user to have detailed database knowledge. In one embodiment, the query by example targeting tool enables a user to send targeted electronic mail messages to a subset of recipients in the user's database. In one embodiment, query by example is implemented using “natural language” statements that look like any English phrase while providing a very high precision tool to build queries. In one embodiment, natural language may also be used to export data for other reasons. For example, while a user is building an electronic mail message, data may be exported from the user's database for the user's reference.

In one embodiment, query by example may use all recipient data available via one or more of a number of data elements previously collected by App Service Modules; such data may include, but is not limited to, recipient domain, recipient local part (the name of the electronic mail message account, before the @), recipient subscription date, recipient number of bounces, if a recipient expires, recipient expiration date, recipient navigator name, recipient navigator version, recipient screen area, recipient screen colors, recipient connection type (LAN, modem, cable, etc) and/or plug-ins installed on the recipient's browser application (e.g., Netscape Navigator). In an additional embodiment, query by example may also work with extended fields, if present, (e.g., age, first name, last name, address, etc.) associated with a list's recipients. In an alternative embodiment, a query by example query may contain statements using information generated for any prior message such as recipient's clicks on any classified link, selecting either the link itself or the classification name for a group of links and/or any data collected by one or more previous EMOs, such as recipient's answers to one or more certain questions.

According to one embodiment, an Editor Client user may first log in and select an electronic mail message list to work on. Once an electronic mail message list has been selected, the Editor Client may access a database via a network (e.g., the Internet, World Wide Web, etc.) and retrieve data including but not limited to a Users' extended database fields (if any), a users' extended fields types (these could be Numeric, String of char, Date and/or DateTime), values that are predefined and don't typically change, e.g. sex (M or F, M or W, etc.), messages already approved and launched. This may include data associated with these messages such as links, classification(s), and subjecting information, and a previous EMO answers.

Following the login process described herein, the Editor Client may have all the necessary data needed to build any QBE statement. Some query statements are built automatically in order to make the QBE process faster.

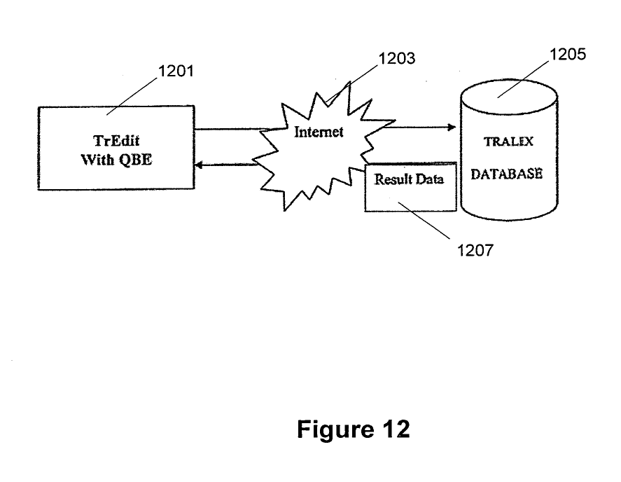

FIG. 12 illustrates a functional block diagram of the retrieval of data using a query by example tool according to one embodiment. In the described embodiment, a query by example statement may next be built. At the last stage of the process of editing and sending message process, a user may build a query by example (QBE) statement using English-like or “natural language” statements, by changing one or more predefined words and/or conditions. As one example, each of the words shown below in boldface could be changed by a user to build a QBE statement in one embodiment.

For example, initially a user may see the following as an illustrative example:

“*Choose users where all of the following apply:”

In the illustrative example the word “all” may take at least one of the following values: any, none, not all and all. The user may then create one or more of their own statements. The Editor Client 1201 may create at least three kinds of statements according to one embodiment: user condition, message condition, and EMO Condition. A “user condition” statement may use all of a user's available data, such as name, browser name, domain part, etc. A “message condition” statement may use data that is generated by both a message and a user's actions on the message. AN EMO condition statement may use previous responses to a EMO.

An exemplary “user condition” type statement may include the following form according to one embodiment:

“*DB User Field Conditional Operator Condition”

In the first DB User field of the “user condition” type statement form, the user may choose any of a number of a recipient's fields such as name, birthday, connection type, etc. In the second Conditional Operator field, the user may choose a conditional word which may vary depending on the type of the data being compared. For example, a Conditional Operator field may include, but is not limited to, any of the following data type conditional words “If the data includes a String of chars (name, domain part, etc.): is equal to, is not equal to, is starting with, is not starting with, contains, not contains.”; “If the data includes a Numeric value (age, num. of bounces, etc.): is equal to, is not equal to, is less than, is less or equal than, is greater, is greater or equal than.”; and “If the data includes a Date or DateTime (birthday, subscription date, etc.): is equal to, is not equal to, is less than, is less than or equal to, is greater than, is greater than or equal to.” In one embodiment, recipient data may stay on an in-house database and may only be referenced as needed for the EMO. For example, the EMO may need to access the user's database to fulfill established merge rules.

Finally, the third Condition field may represent the condition that has to be matched. For example, if the first selected field was Sex having one of two values: M and F, when the user selects or clicks on Condition, a popup menu may appear showing only these two values. The user may then choose any one of the available options. In an alternative example, if the first selected field was domain part, a text input window may appear rather than the popup menu in one embodiment.

An exemplary “user condition” type statement according to one embodiment might therefore be Choose users where all of the following apply: User domain starts with yahoo.com.

According to one embodiment, a user may change any of the statement fields by selecting or clicking on any field to popup a window where the user can change the field's (e.g., DB User field, Conditional Operator field, or Condition field) value.

An exemplary “message condition” type statement may include the following form according to one embodiment of the present invention:

“*Conditional Operator Condition”

In the first Conditional Operator field of the “message condition” type statement form a user may have at least four options according to one embodiment: 1) recipient clicked on, 2) recipient not clicked on 3) recipient opened electronic mail message, and 4) recipient did not open electronic mail message. If the user chooses either recipient clicked on or recipient not clicked on, then in the second Condition field, a user may select either a classification (e.g., a trewey classification) or any particular link inside any classification for any launched message according to one embodiment. Options for the Condition field may then be shown to the user utilizing a popup window where the user can choose any message, and then any class or link inside a class. If the user chooses either recipient opened the electronic mail message or recipient did not open the electronic mail message, in the second condition field the user may choose a message by its subject and/or by its launch time according to one embodiment.

Exemplary “message condition” type statements according to alternative embodiments might therefore include a User not clicked on http://www.tralix.com/ (In this example, the user selected a link, rather than a class), a User clicked on Novels→Science Fiction→Star Trek, (Here, the user selected a class which may contain zero or more links) and a user opened “Mexicanas e fares (launched on 5^{th} of February)” (Here, the user selected both an electronic mail message subject and a launch date).

A user may build as many statements as he or she likes, combining any number of “message condition” and “user condition” statements. Because the data may already be contained within the Editor Client, the described QBE building process may be accomplished very quickly.

FIG. 12 illustrates a functional block diagram of the retrieval of data using a query by example tool according to one embodiment. After a QBE statement is built, the query may then be stored and executed. In one embodiment, the Editor Client 1201 may not perform any query to the database during the time the user is building the QBE. When the user finishes the process, he or she may optionally see how many recipients the query is applicable to by showing the number of recipients but not the recipient's data.

When an electronic mail message is sent, the associated query statements are parsed and converted to standard structured query language (SQL) statements which may be compatible with any number of known database systems (e.g., relational databases, object-oriented databases, etc.). Then the SQL statements may be sent to the server along with the electronic mail message data. The electronic mail message may be stored in the database as well as the SQL statements. When the message is ready to be launched, an application TrDaemon on the server side, may read and execute the SQL statements, generating the messages to the recipients that match the query and launch the electronic mail message to them. The electronic mail messages are sent over the Internet 1203. The result data 1207 from the EMO may be sent back from the recipient to a database 1205.

### Remote Database Access

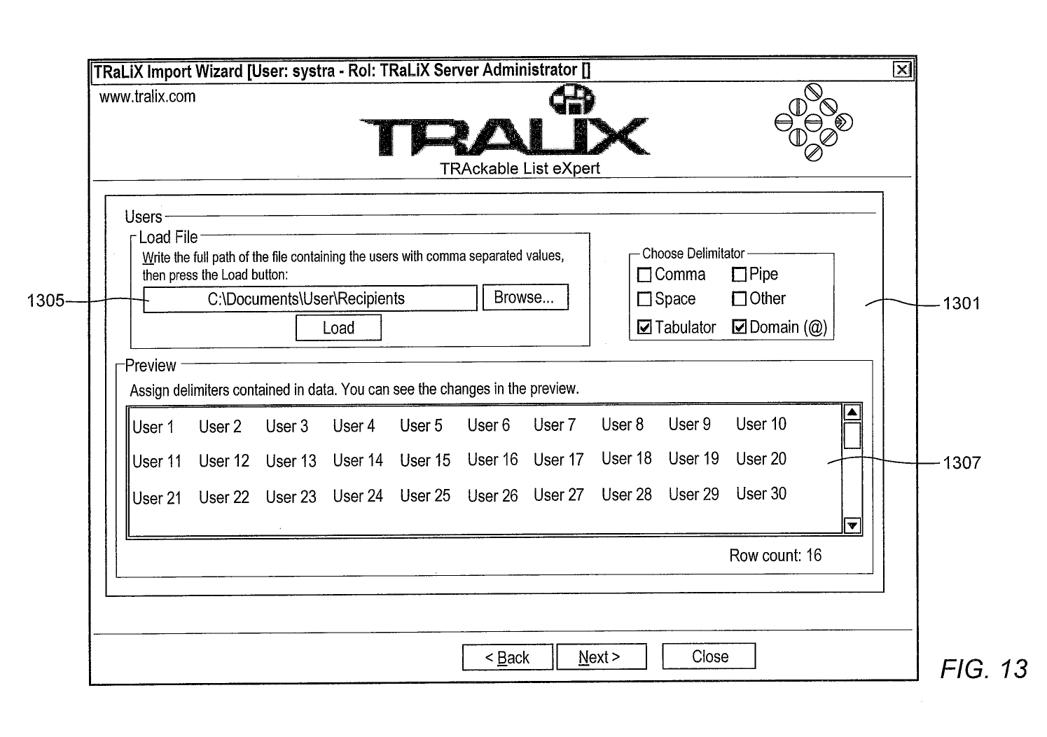

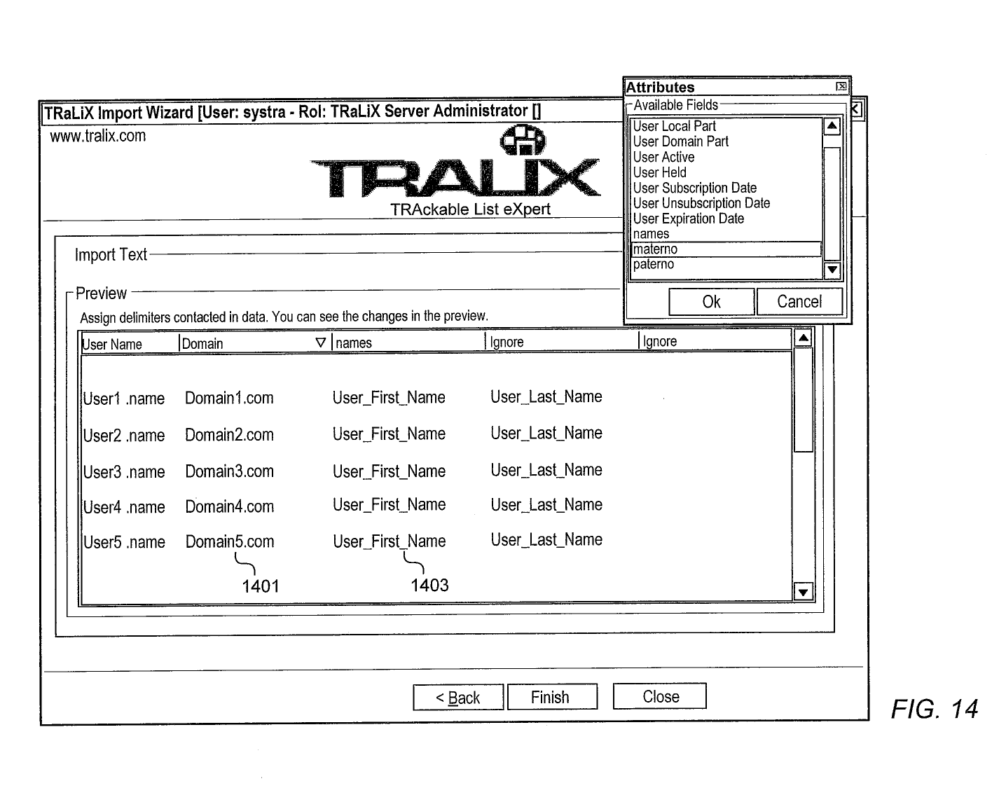

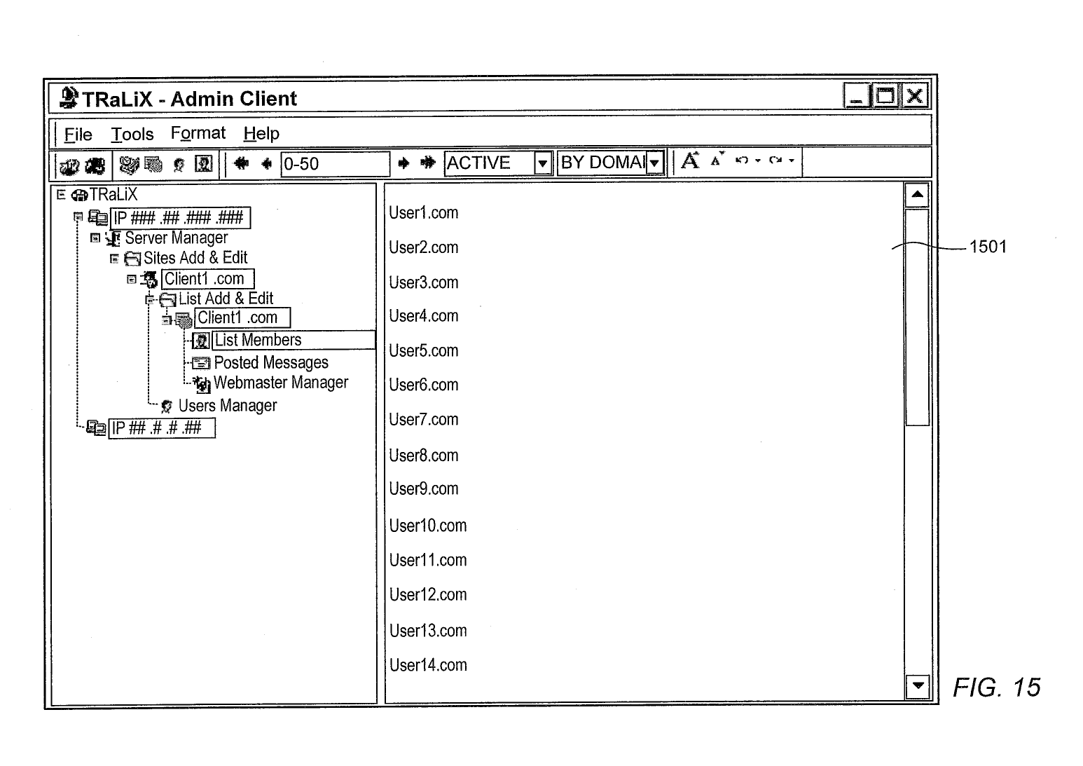

FIGS. 13, 14, and 15 illustrate display output of an Import Client component according to one embodiment. In one embodiment, data may be accessed using either an Import Client component (e.g., for batch jobs to obtain electronic mail message list information, electronic mail message addresses, names, etc.) or a Database (DB) Merge component for dynamic incorporation of data into electronic mail messages. Both may obtain information from various sources including a delimited text file such as a comma separated value (CSV) file, a database view, and/or XML schema.

A database view may contain a client-defined/limited portion of data from a client database not hosted within the App Server app. In one embodiment, a database view may contain data from at least an electronic mail message address field so that electronic mail messages can be sent out. The list of electronic mail message addresses may then be sent to an App Service Module component.

A client may limit the data that is sent to the App Service Module component by selecting what information is to be sent (e.g., send the name and electronic mail message address but not the home address or phone number fields, etc.). In one embodiment, no information may be sent about client customers in a database who are not going to receive the electronic mail message to be currently transmitted.

In one embodiment, the EMO may be used to gather information including, but not limited to, a date and time the electronic mail message was opened, where the electronic mail message was opened, if the electronic mail message was forwarded, a recipient's operating system name and version, an engine version of the recipient's browser, whether the recipient's cookies are enabled or disabled, a recipient's screen resolution, a recipient's deep screen resolution (such as, but not limited to a number of colors, patlette, number of bits), information about the recipient's java version, timestamps on first openings and clickthroughs, language, machine internet protocol (IP), and plug-ins. In one embodiment, EMOs may also be used to track clickthroughs by categories (for example, as defined by a list administrator) and paths (such as behavioral analysis).

In one embodiment, a user may select a group of recipients using the import interface 1301. For example, the user may enter a filename 1305 with a list of recipients 1307. In one embodiment, the user may also import the recipient's name and domain 1401 and specify what parts of the recipient's name 1403 to use with the electronic mail message utilizing the EMO. In one embodiment, the Admin Client may also be used to view a list 1501 of the electronic mail message address selected to use a certain EMO.

### Classification of Links

In one embodiment, categorization information (e.g., one or more classifications such as Dewey Decimal classifications, Library of Congress classifications, “trewey” classifications, any combination thereof, or the like) may be sent from a client to App Service Module component utilizing an App Client Module software program. In one embodiment, each category may be associated with a category number based on a three-level, per-list classification system. Such a classification system may include for example, 100 first-level categories, 1000 second-level categories, and 10,000 third-level categories. In one embodiment, the three category levels may be organized from a broad level of classification at the first level, to a more narrow level of classification at the second level, to a most narrow level of classification at the third level. A unique URL or “link” associated with the category number may then be created within each electronic mail message to be transmitted. When a customer/end-user receives the electronic mail message and clicks on the link included therein, he/she may be redirected first to an App Service server which identifies the category of the link and then to the final page destination. Because each link is unique, the specific electronic mail message recipient who accessed the link may also be determined at the redirection App server destination. In an alternative embodiment, other information may be obtained about a customer/end-user when the link is activated such as whether JAVA or cookies are enabled, their geographic location, etc. In one embodiment, links may be encrypted. Also, in one embodiment, data transmitted for the EMO may be encrypted.

### Additional Embodiments

In one alternative embodiment, a technique known as “round-robin subjecting” may be utilized in which one or more test subject lines are associated with an electronic mail message to be sent to a number of subscribers of an electronic mail message list. The test-subjected electronic mail messages may then be transmitted to a portion of the total number of list subscribers to determine the effectiveness and/or impact of the test subject.

In one embodiment, the effectiveness and/or impact of the test-subjected electronic mail messages is determined by monitoring certain attributes of the transmitted electronic mail messages such as what percentage or portion of the total number of test-subject messages were opened, how quickly following delivery the messages were opened, how many of the messages were forwarded, etc. In another alternative embodiment, the effectiveness and/or impact of the test subjected electronic mail messages is utilized to automatically associate or assign a subject to electronic mail messages to be transmitted to other subscribers' of the electronic mail message list.

As one example, a number of test message groups could be created each with its own test subject line and transmitted to a number of subscribers to an electronic mail message list (e.g., 5% of the subscribers to the list) with the bulk or remainder of the electronic mail messages being transmitted with the test subject line having the greatest effectiveness or impact. Alternatively, a first subject line could be associated with a portion (e.g., 5%) of the total number of messages to be transmitted to a given electronic mail message list. It may then be determined whether the monitored effectiveness or impact of the electronic mail messages including the first subject line met and/or exceeded a predefined threshold (e.g., 60% of the messages opened within 24 hours of delivery). The first subject line may then be associated with the remaining (i.e., 95%) messages to be transmitted to the list if the threshold was met or exceeded and a second/alternate subject line could be utilized otherwise.

In another embodiment, the system may be utilized to automatically attach secure documents to each of a number of electronic mail messages for transmission to a number of recipients where each secure document is unique to a particular user. For example, a secure portable document format (PDF) document may be attached to each of a number of electronic mail messages to be transmitted to members or subscribers of an electronic mail message list. In an alternative embodiment such a technique may be utilized to transmit secure and personalized billing information to members or subscribers of an electronic mail message list such as customers of a particular business.

In one embodiment, after a first round of results are received, the user may select another set of recipients out of the recipients that responded to send another electronic mail message to. For example, the user may select a set of recipients who responded affirmatively to one question in the electronic mail message to send an advertisement to or to send an additional EMO.

In one embodiment, the system may verify if the recipient of an electronic mail message with an EMO has a text-only-electronic mail message client. If the recipient of the unique electronic mail message is a text-only recipient, the unique electronic mail message may include a link to an online website to allow the recipient to view the unique electronic mail message. In one embodiment, the link may be to an online website with personalized information about the recipient. Other links and views are also contemplated.

In one embodiment, the system may design a marketing program that may include multiple personalized messages to be sent during the life of a marketing program in an automatic manner. In one embodiment, the personalized messages may be sent according to when the recipient responds to the electronic mail messages. Other timing is also contemplated. In one embodiment, a flowchart of the messages and when the messages will be sent may be prepared by the user. In one embodiment, a flowchart may be prepared for the user using the automated inputs provided by the user.

In one embodiment, if the recipient replies to the electronic mail message by using a “Reply” feature instead of the designated “Submit” button, the system may recognize the message received, identify a relative recipient, and add keep track of the results of the electronic mail message. In one embodiment, the electronic mail message may be archived. Other responses to inbound messages are also contemplated.

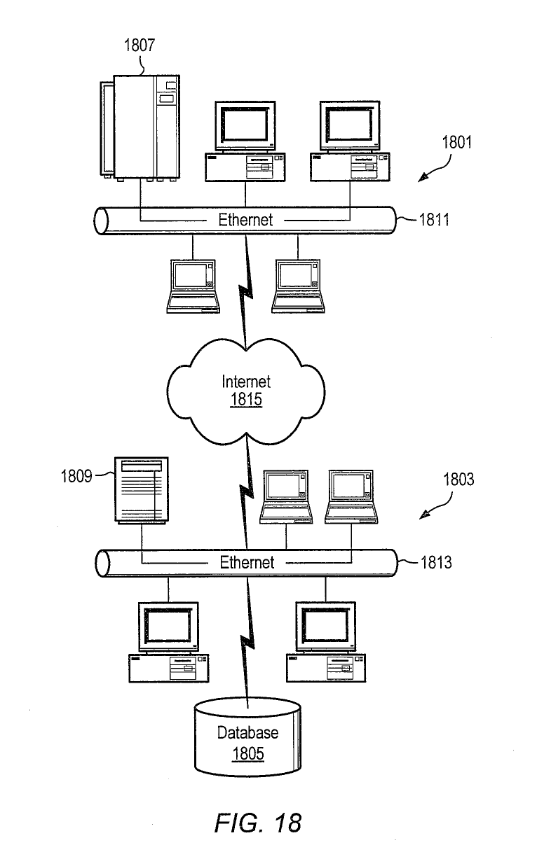

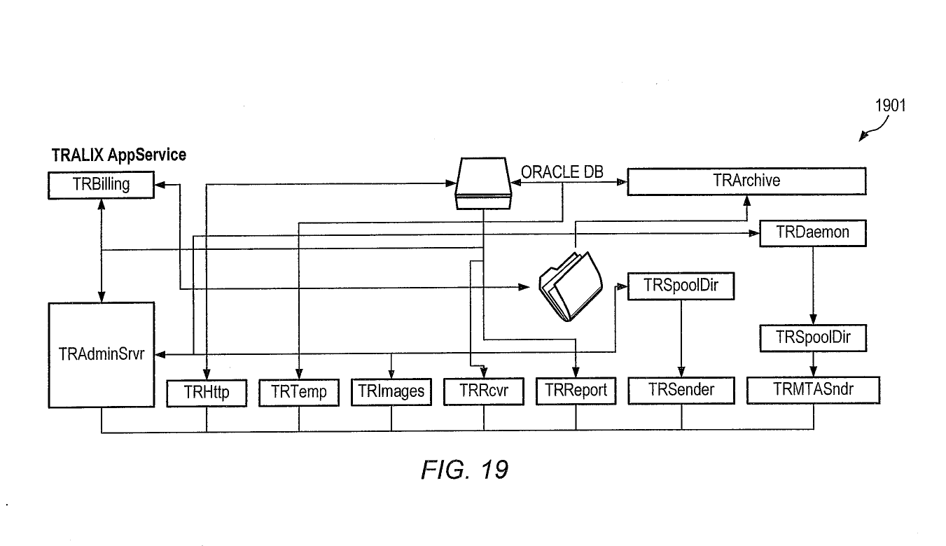

FIG. 18 shows an embodiment of a communication network for the system according to one embodiment. In one embodiment, a customer local area network (LAN) 1803 may be coupled to a LAN 1801 over the Internet 1815. In one embodiment, the customer LAN may contain terminals connected over an Ethernet 1813 and coupled to a customer database 1805. The customer database 1805 may contain potential electronic mail message recipient information (such as, but not limited to, name, electronic mail message address, age, and address). Other information stored on each potential recipient is also contemplated. In one embodiment, the LAN 1801 may have terminals coupled through an Ethernet 1811. An application server 1807 may be coupled to the LAN 1801, and an application server 1809 may be coupled to the customer LAN 1803. Other systems are also contemplated. In one embodiment, an App server 1901 coupled to the LAN may provide several different functions (see FIG. 19)

In one embodiment, each electronic mail message may have a header which includes a link to a website (which may be encrypted) showing where and when the recipient agreed to join a list of people to be sent an electronic mail message by the client. Other information about the recipient agreeing may also be included. In one embodiment, this header may be used by junk electronic mail message detectors to determine if the recipient should receive the electronic mail message. In one embodiment, the header may indicate to a junk electronic mail message detector to allow the electronic mail message to go to the recipient.

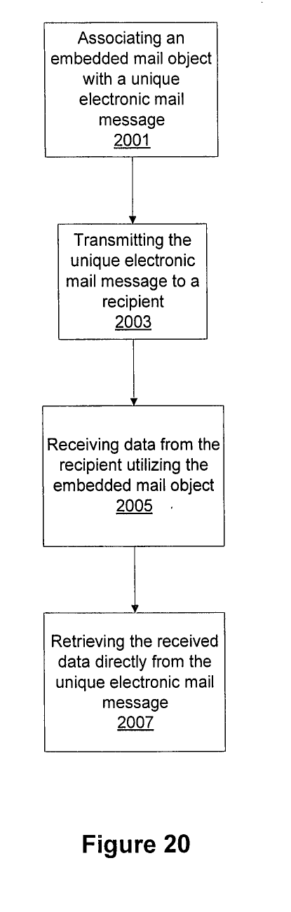

FIG. 20 shows a flowchart of an embodiment of embedding EMOs. In 2001, an embedded mail object may be associated with a unique electronic mail message. In 2003, the unique electronic mail message may be transmitted to a recipient. In 2005, data from the recipient may be received utilizing the embedded mail object on a user level. In 2007, the received data may be directly retrieved from the unique electronic mail message.

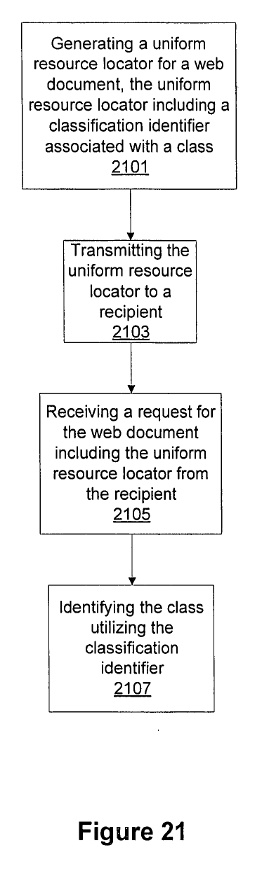

FIG. 21 shows a flowchart of an embodiment of using URLs. In 2101, a uniform resource locator may be generated for a web document, the uniform resource locator including a classification identifier associated with a class. In 2103, the uniform resource locator may be transmitted to a recipient. In 2105, a request for the web document including the uniform resource locator may be received from the recipient. In 2107, the class may be identified utilizing the classification identifier.

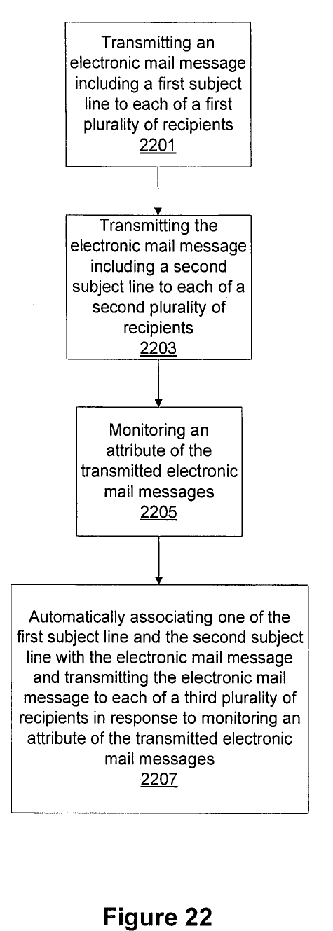

FIG. 22 shows a flowchart of an embodiment of monitoring subject lines for electronic mail messages with EMOs. In 2201, an electronic mail message may be transmitted including a first subject line to each of a first plurality of recipients. In 2203, the electronic mail message may be transmitted including a second subject line to each of a second plurality of recipients. In 2205, an attribute of the transmitted electronic mail messages may be monitored. In 2207, one of the first subject line and the second subject line may be automatically associated with the electronic mail message and the electronic mail message may be transmitted to each of a third plurality of recipients in response to monitoring an attribute of the transmitted electronic mail messages.

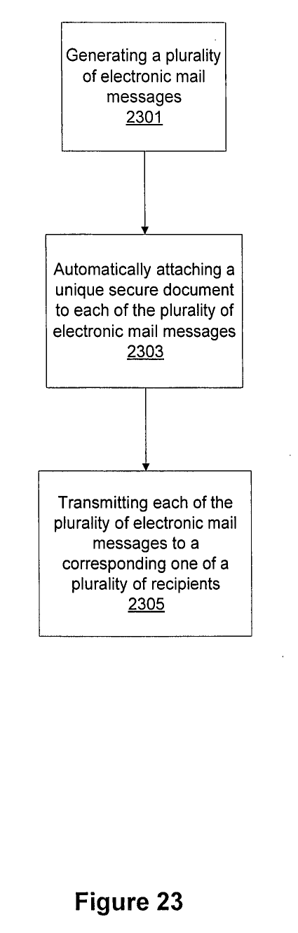

FIG. 23 shows a flowchart of an embodiment of attaching secure documents to electronic mail messages with EMOs. In 2301, a plurality of electronic mail messages may be generated. In 2303, a unique secure document may be automatically attached to each of the plurality of electronic mail messages. In 2305, each of the plurality of electronic mail messages may be transmitted to a corresponding one of a plurality of recipients.

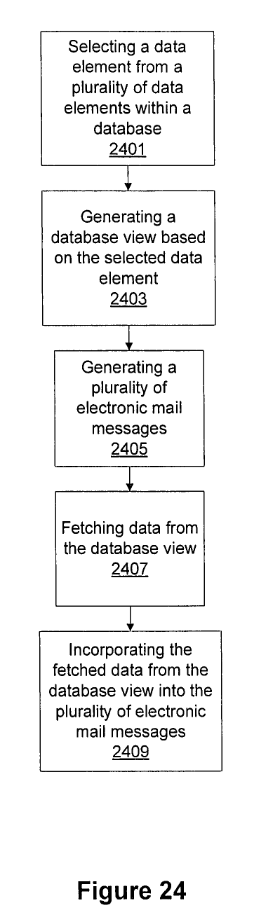

FIG. 24 shows a flowchart of an embodiment of incorporating database information in an electronic mail message with a EMO. In 2401, a data element may be selected from a plurality of data elements within a database. In 2403, a database view may be generated based on the selected data element. In 2405, a plurality of electronic mail messages may be generated. In 2407, data may be fetched from the database view. In 2409, the fetched data may be incorporated from the database view into the plurality of electronic mail messages.

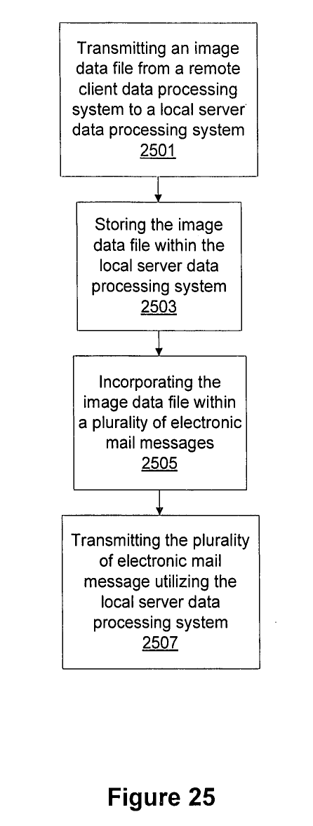

FIG. 25 shows a flowchart of an embodiment using a remote client system and a local server. In 2501, an image data file may be transmitted from a remote client data processing system to a local server data processing system. In 2503, the image data file may be stored within the local server data processing system. In 2505, the image data file may be incorporated within a plurality of electronic mail messages. In 2507, the plurality of electronic mail messages may be transmitted utilizing the local server data processing system.

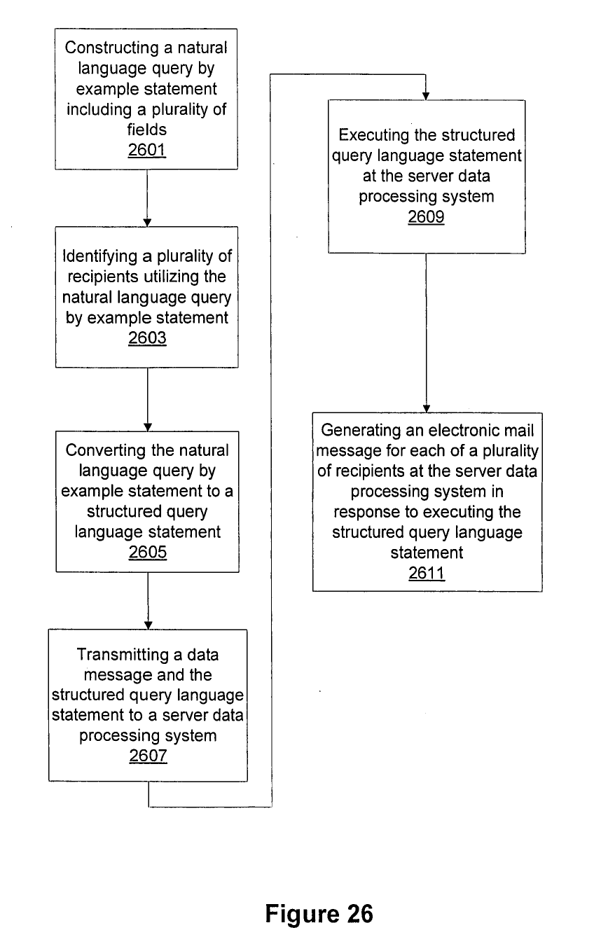

FIG. 26 shows a flowchart of an embodiment of using structured query language with EMOs. In 2601, a natural language query may be constructed by example statement including a plurality of fields. In 2603, a plurality of recipients may be identified utilizing the natural language query by example statement. In 2605, the natural language query may be converted by example statement to a structured query language statement. In 2607, a data message and the structured query language statement may be transmitted to a server data processing system. In 2609, the structured query language statement may be executed at the server data processing system. In 2611, an electronic mail message for each of a plurality of recipients may be generated at the server data processing system in response to executing the structured query language statement.

Various embodiments may further include receiving or storing instructions and/or information implemented in accordance with the foregoing description upon a carrier medium. Suitable carrier media may include storage media or memory media such as magnetic or optical media, e.g., disk or CD-ROM, as well as transmission media or signals such as electrical, electromagnetic, or digital signals, conveyed via a communication medium such as a network and/or a wireless link

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method, comprising:
creating a unique electronic mail message for a recipient;
creating a unique uniform resource locator (URL) link; wherein the unique electronic mail message comprises the unique uniform resource locator (URL) link;
transmitting the unique electronic mail message to the recipient; and
receiving an indication that the unique URL has been accessed by the recipient, wherein the unique URL is operable to identify the recipient to a server receiving the indication that the URL link has been accessed.

2. The method of claim 1, further comprising transmitting separate unique electronic mail messages to different recipients, wherein each unique electronic mail message comprises a URL link unique to an intended recipient of the unique electronic mail message.

3. The method of claim 1, wherein the server is operable to identify a specific recipient of the unique URL based on the text of the unique URL.

4. The method of claim 1, wherein the unique URL refers the recipient to an online website to view the electronic mail message.

5. The method of claim 1, further comprising receiving information from a recipient accessing the URL link.

6. The method of claim 5, wherein the received information comprises a geographic location of the recipient, indication of enabled cookies on recipient system, recipient system screen resolution, recipient system operating system, type of connection to recipient system, whether Javascript is enabled on the recipient system, type of browser on recipient system, version of browser on recipient system, or deep screen resolution of recipient system.

7. The method of claim 1, wherein the unique URL link is encrypted.

8. A system, comprising:
a processor;
a memory coupled to the processor and configured to store program instructions executable by the processor to:
create a unique electronic mail message for a recipient;
create a unique uniform resource locator (URL) link; wherein the unique electronic mail message comprises the unique uniform resource locator (URL) link;
transmit the unique electronic mail message to the recipient; and
receive an indication that the unique URL has been accessed by the recipient, wherein the unique URL is operable to identify the recipient to a server receiving the indication that the URL link has been accessed.

9. The system of claim 8, wherein the program instructions are further executable to transmit separate unique electronic mail messages to different recipients, wherein each unique electronic mail message comprises a URL link unique to an intended recipient of the unique electronic mail message.

10. The system of claim 8, wherein the server is operable to identify a specific recipient of the unique URL based on the text of the unique URL.

11. The system of claim 8, wherein the unique URL refers the recipient to an online website to view the electronic mail message.

12. The system of claim 8, wherein the program instructions are further executable to receive information from a recipient accessing the URL link.

13. The system of claim 8, wherein the received information comprises a geographic location of the recipient, indication of enabled cookies on recipient system, recipient system screen resolution, recipient system operating system, type of connection to recipient system, whether Javascript is enabled on the recipient system, type of browser on recipient system, version of browser on recipient system, or deep screen resolution of recipient system.

14. The system of claim 8, wherein the unique URL link is encrypted.

15. A computer-readable storage medium, comprising program instructions, wherein the program instructions are computer-executable to:
create a unique electronic mail message for a recipient;
create a unique uniform resource locator (URL) link; wherein the unique electronic mail message comprises the unique uniform resource locator (URL) link;
transmit the unique electronic mail message to the recipient; and
receive an indication that the unique URL has been accessed by the recipient, wherein the unique URL is operable to identify the recipient to a server receiving the indication that the URL link has been accessed.

16. The computer-readable storage medium of claim 15, wherein the program instructions are further executable to transmit separate unique electronic mail messages to different recipients, wherein each unique electronic mail message comprises a URL link unique to an intended recipient of the unique electronic mail message.

17. The computer-readable storage medium of claim 15, wherein the server is operable to identify a specific recipient of the unique URL based on the text of the unique URL.

18. The computer-readable storage medium of claim 15, wherein the unique URL refers the recipient to an online website to view the electronic mail message.

19. The computer-readable storage medium of claim 15, wherein the program instructions are further executable to receive information from a recipient accessing the URL link.

20. The computer-readable storage medium of claim 15, wherein the received information comprises a geographic location of the recipient, indication of enabled cookies on recipient system, recipient system screen resolution, recipient system operating system, type of connection to recipient system, whether Javascript is enabled on the recipient system, type of browser on recipient system, version of browser on recipient system, or deep screen resolution of recipient system.

21. The computer-readable storage medium of claim 15, wherein the unique URL link is encrypted.
